(19) United States
(12) Patent Application Publication
(10) Pub. No.: US 2026/0102879 A1
(43) Pub. Date: Apr. 16, 2026

(54) PITCH BAR SELF-ADJUSTING CLAMP

(71) Applicant: Robert N. Poole, Prescott, AZ (US)

(72) Inventor: Robert N. Poole, Prescott, AZ (US)

(21) Appl. No.: 19/356,384

(22) Filed: Oct. 13, 2025

Related U.S. Application Data
(60) Provisional application No. 63/707,095, filed on Oct. 14, 2024.

(51) Int. Cl. B25B 5/12; B25B 5/04; B25B 5/08; B25B 5/10; B25B 7/12

(52) U.S. Cl. CPC B25B 5/125; B25B 5/04; B25B 5/082; B25B 5/101; B25B 5/103; B25B 7/123

(57) ABSTRACT

A pitch bar self-adjusting clamp including a fixture having a handle and an opposing stationary jaw, a co-acting jaw pivoted to the fixture, a lever pivoted to the co-acting jaw, a guide bar pivotally coupled to the handle proximate the stationary jaw and movably coupled to the handle, and a toggle assembly coupled between the lever and the guide bar. The toggle assembly includes a locking element, a link pivoted to the lever, and a cam pivoted to the link and to the locking element. The cam is movable between a first condition permitting the locking element to reciprocate along the guide bar and a second condition bearing against the guide bar and canting the locking element into frictional engagement against the guide. An adjustment mechanism is coupled to the proximal end of the guide bar for movement between a low pitch position and a high pitch position.

### CROSS-REFERENCE TO RELATED APPLICATION

This application claims the benefit of U.S. Provisional Application No. 63/707,095, filed 14 Oct. 2024.

### FILED OF THE INVENTION

This invention relates to mechanical clamps and more specifically to self-adjusting clamps.

### BACKGROUND OF THE INVENTION

In the field of clamping devices the art is filled with various locking adjustable pliers wrenches for gripping and locking onto objects within a rather wide size range. The innovations in such clamping devices are marked largely by improvements to the toggle mechanisms that permit the jaws to not only accommodate differently sized objects but also to lock onto the objects with varying degrees of force. Existing toggle mechanisms employ an adjustment component for use in adjusting the distance between the jaws so that they can grip and lock onto differently sized objects. The jaws must be pre-adjusted so that they can engage and grip an object, regardless of the size. As a result, existing locking adjustable clamping devices cannot be used with only one hand in the sequential gripping of differently sized objects, because a pre-adjustment of the jaws is required from the gripping of one object to the gripping of another differently sized object.

This required pre-adjustment of the jaws in the sequential gripping of differently sized objects is a significant deficiency in the art and it is clear that a clamping device that could be employed for sequentially gripping differently sized objects with a selected gripping force without having to be sequentially pre-adjusted would mark a significant improvement over the prior art. The present invention achieves this and provides artisans with an adjustable clamping device that is easy to construct and easy to employ with only one hand for sequentially gripping differently sized objects without the need for sequentially pre-adjusting the jaws.

It would be highly advantageous, therefore, to remedy the foregoing and other deficiencies inherent in the prior art.

### SUMMARY OF THE INVENTION

Briefly, to achieve the desired objects and advantages of the instant invention, provided is a pitch bar self-adjusting clamp. The pitch bar self-adjusting clamp includes a fixture having a handle and an opposing stationary jaw, a co-acting jaw pivoted to the fixture, a lever pivoted to the co-acting jaw and a guide bar having a proximal end and a distal end, the distal end pivotally coupled to the handle proximate the stationary jaw and the proximal end movably coupled to the handle proximate the terminal end. A toggle assembly is coupled between the lever and the guide bar. The toggle assembly includes a locking element disposed on the guide for reciprocal and canting movement; a link pivoted to the lever, and a cam pivoted to the link and to the locking element. The cam is movable between a first condition permitting the locking element to reciprocate along the guide bar and a second condition bearing against the guide bar and canting the locking element into frictional engagement against the guide. An adjustment mechanism is coupled to the proximal end of the guide bar for movement between a low pitch position and a high pitch position.

In a specific aspect, the cam includes a camming surface characterized by an outward curvature that faces the guide bar and is angularly disposed relative thereto. The angular disposition of the cam surface determines a clamping force of the stationary jaw and the co-acting jaw. An adjustment mechanism coupled to the proximal end of the guide bar to adjust the angular disposition of the camming surface relative the guide bar.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a side view of a pitch bar self-adjusting clamp in accordance with the present invention, showing a guide bar at a low pitch (bar up);

FIG. 2 is a side view of the pitch bar self-adjusting clamp of FIG. 1 showing the guide bar at a high pitch (bar down);

FIG. 3 is fragmented perspective view of the toggle assembly of FIGS. 1 and 2;

FIG. 4 is side view of the guide bar and adjustment mechanism of FIG. 2 with the guide bar in the high pitch (bar down) position;

FIG. 5 is side view of the guide bar and adjustment mechanism of FIG. 1 with the guide bar in the low pitch (bar up) position;

FIG. 6 is a side view of another embodiment of a pitch bar self-adjusting clamp in accordance with the present invention;

FIG. 7 is a partial cut-away side view of the clamp of FIG. 6 showing the guide bar at a low pitch (bar up) position using a rack and pinion adjustment mechanism;

FIG. 8 is a partial cut-away side view of the clamp of FIG. 6 showing the guide bar at a high pitch (bar down) position;

FIG. 9 is a partial exploded view of the guide bar and adjustment mechanism; and

FIG. 10 is a side view of another embodiment of a pitch bar self-adjusting clamp in accordance with the present invention, with the guide bar in the bar up, low pitch position;

FIG. 11 is a side view of the clamp of FIG. 10 with the guide bar in a middle position; and

FIG. 12 is a side view of the clamp of FIG. 10 with the guide bar in a bar down, high pitch position.

### DETAILED DESCRIPTION OF THE PREFERRED EMBODIMENTS

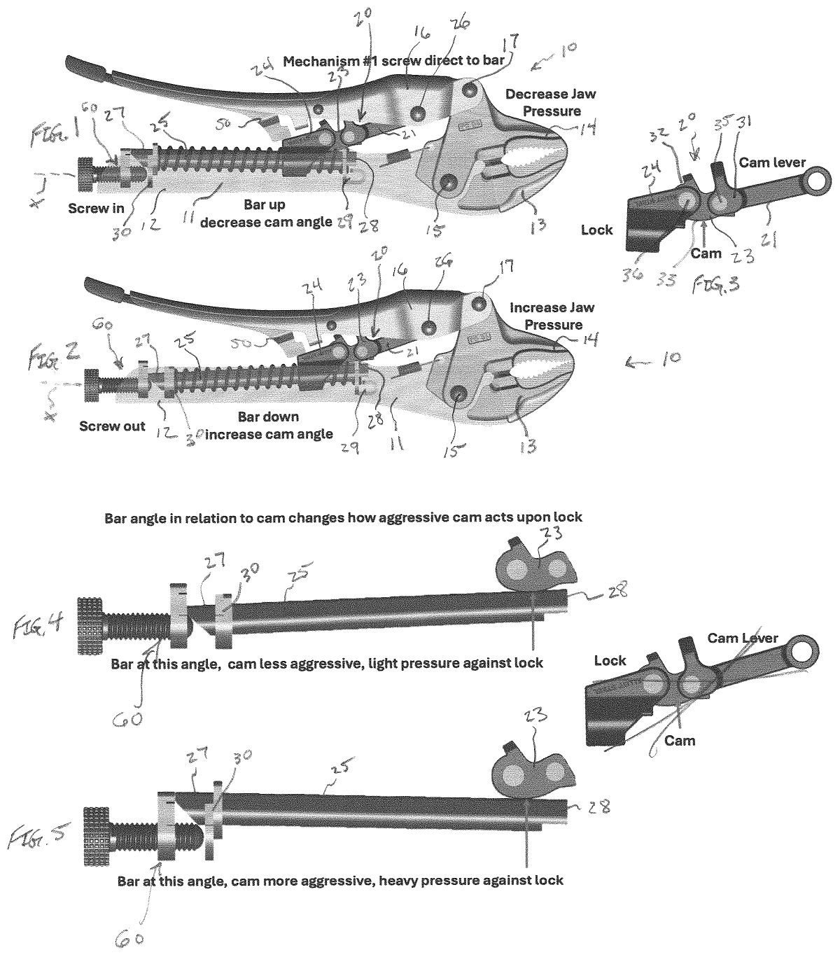

Turning now to the drawings in which like reference characters indicate corresponding elements throughout the several views, attention is directed to FIG. 1 which illustrates a side elevation of a pitch bar self-adjusting clamp 10 in accordance with the invention. Clamp 10 includes an elongate fixture 11 having a handle 12 at its rearward end and an opposing stationary jaw 13 at its forward end. A co-acting movable jaw 14 is pivoted to fixture 11 with a pivot pin 15. A lever 16 is pivoted to jaw 14 with a pivot pin 17 and extends rearwardly.

A toggle assembly 20 is disposed between fixture 11 and lever 16 rearwardly of jaws 13,14. The structural components of toggle assembly 20 are illustrated with additional reference to FIG. 3, and include a link 21, a cam 23, and a locking element 24 carried by a guide bar 25. Guide bar 25 is elongate with a proximal end 27 toward a terminal end of handle 12 and a distal end 28 toward jaw 13. Guide bar 25 is disposed along substantially the entire length of handle 12 with distal end 28 pivotally fixed to handle 12 by bracket 29 proximate stationary jaw 13 and proximal end 27 movably attached by sliding fixture 30 proximate a terminal end 34 of handle 12. Guide bar 25 passes through locking element 24 and resides in an elongate recess formed into handle 12. Locking element 24 is closely arranged on guide bar 25 for sliding/reciprocal movement along the length of guide bar 25 and for canting movement relative guide bar 25. Locking element 24 is partially received in the elongate recess formed into handle 12. Guide bar 25 defines a central axis X, and the ability of locking element 24 to cant on guide bar 25 is characterized by its ability to deviate angularly relative to axis X so as to frictionally engage guide bar 25. Link 21 is pivoted to lever 16 with a pin 26 rearward of pin 17.

Cam 23 has opposing extremities 31, 32 and a camming surface 33. Extremity 31 is considered a rearward extremity and extremity 32 is considered a forward extremity. Camming surface 33 is characterized by an outward curvature that faces fixture 11 and is angularly disposed relative thereto. Link 21 is pivoted to cam 23 at an extension of extremity 31 with a pivot pin 35 and locking element 24 is pivoted to cam 23 at a somewhat rearward side of extremity 32 with a pivot pin 36. Cam 23 is movable between a first condition permitting locking element 24 to reciprocate along guide bar 25 and a second condition bearing against guide bar 25 and canting locking element 24 into frictional engagement against guide bar 25.

Lever 16 is movable between an opened position and a closed position. In the opened position of lever 16, jaws 13,14 are opened and locking element 24 is located in or otherwise proximate its forward most position and camming surface 33 is spaced from and angularly disposed relative to guide bar 25. In response to movement of lever 16 toward handle 12, jaw 14 moves toward jaw 13 until jaws 13,14 together engage a work piece disposed therebetween and link 21 pivots at pin 26, which causes cam 23 to pivot toward guide bar 25 at pin 36. As link 21 and cam 23 so pivot, camming surface 33 moves toward guide bar 25 and the angular disposition of camming surface 33 and link 21 relative to guide bar 25 progressively lessens. With jaws 13,14 engaged against a work piece positioned therebetween, continued movement of lever 16 toward handle 12 drives toggle assembly 20, causing locking element 24 to slide rearwardly and link 21 and cam 23 to pivot toward guide bar 25 until which point camming surface 33 presents against guide bar 25. At the point of contact between camming surface 33 and guide bar 25, cam 23 pivots ever so slightly away from guide bar 25 and drives locking element 24 away from guide bar 25 at pin 36, which causes locking element 24 to cant and thus frictionally engage guide bar 25. Cam 23 thus acts as a lever, driving locking element 24 so as to cause it to cant and frictionally engage guide bar 25 in response to a force applied to lever 16 in a direction toward handle 12, which force is transferred to cam 23 by link 21. This frictional engagement frictionally locks locking element 24 to guide bar 25. In response to continued force applied to lever 16 toward handle 12 and with locking element 24 frictionally locked against guide bar 25, a clamping pressure is applied by jaws 13,14 across the work piece positioned therebetween and lever 16 is moved into its closed position. In the closed position of lever 16, an over-the-center locking occurs at link 21 in relation to the pivoting action that takes place at pins 26 and 35, thus locking lever 16 in its closed position. This process takes place regardless of the size of the work piece positioned between jaws 13,14. To open clamp 10 or otherwise release jaws 13,14 from the work piece, lever 16 need only be forcibly moved out of its closed position. A conventional release lever 50 pivoted to lever 16 can be employed for acting against a portion of toggle assembly 20, for prying lever 16 out of its closed position.

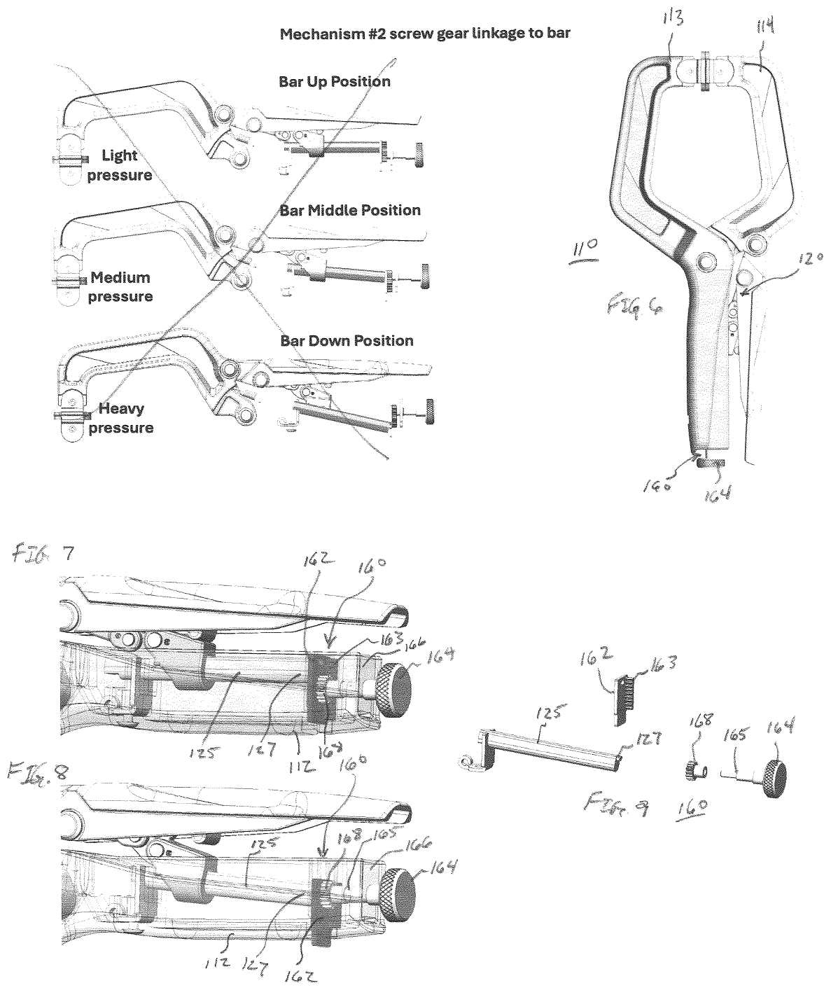

With additional reference to FIGS. 4 and 5, the clamping force of jaws 13,14 are adjusted by altering the position of cam 23 and camming surface 33 relative guide bar 25. Alteration of this position is accomplished, not by moving cam 23, but by moving guide bar 25 using an adjustment mechanism 60. Proximal end 27 is moved between a low pitch position (FIGS. 1 and 5) and a high pitch position (FIGS. 2 and 4) while distal end 28 remains fixed. Thus, in the low pitch position, proximal end of guide bar 25 is raised, leveling guide bar 25 and reducing the pitch. In the high pitch position, proximal end 27 is lowered, increasing the pitch of guide bar 25. With guide bar 25 in the low pitch position, cam 23 is closer and with less angular disposition to guide bar 25. The closer cam 23 is to guide bar 25 and the lesser the angular disposition of cam 23 is relative to guide bar 25 in the starting position the farther rearward is the engagement of cam 23 to guide bar 25 and the coincident frictional engagement between locking element 24 and guide bar 25. Thus, in the low pitch position, the engagement of cam 23 to guide bar 25 is farther rearward. With guide bar 25 in the high pitch position, cam 23 is further from and with more angular disposition to guide bar 25. The further cam 23 is to guide bar 25 and the greater the angular disposition of cam 23 is relative to guide bar 25 in the starting position the farther forward is the engagement of cam 23 to guide bar 25 and the coincident frictional engagement between locking element 24 and guide bar 25. Thus, in the high pitch position, the engagement of cam 23 to guide bar 25 is farther forward.

The distance from and angular disposition of cam 23 relative to guide bar 25 is determinative of the clamping pressure applied by jaws 13,14 across a work piece positioned therebetween when lever 16 is in its closed. Because the over-the-center clamping action provided between link 21 and lever 16 and the coincident pressure applied by jaws 13,14 across a work piece positioned therebetween decreases the further rearwardly (low pitch FIG. 1) the frictional engagement occurs between locking element 24 and guide bar 25 and increases the further forwardly (high pitch FIG. 2) the frictional engagement occurs between locking element 24 and guide bar 25, adjustment of the clamping pressure is controlled by adjustment mechanism 60. In this regard, using adjusting mechanism 60 to position guide bar 25 toward the high pitch position increases the distance of cam 23 from guide bar 25 and increases the angular disposition of camming surface 33 relative to guide bar 25, which results in an increased clamping pressure applied by jaws 13,14 across a work piece positioned therebetween in the closed position of lever 16. using adjusting mechanism 60 to position guide bar 25 toward the low pitch position decreases the distance of cam 23 from guide bar 25 and decreases the angular disposition of camming surface 33 relative to guide bar 25, which results in a decreases clamping pressure applied by jaws 13,14 across a work piece positioned therebetween in the closed position of lever 16.

Adjustment mechanism 60 includes a screw 62 having a tip 63 carried by a plate 64 attached to terminal end 34 of handle 12. Screw 62 can be threaded through plate 64 in reciprocating movement with tip 63 moving forwardly and rearwardly. In the fully forwardly threaded direction (FIGS. 1 and 5) tip 63 engages a slanted end surface 65 of proximal end 27 of guide bar 25, pushing proximal end 27 into the bar up, low pitch position. As screw 62 is retracted and tip 63 is moved rearwardly, bar 25 slides downwardly on tip 63 to the bar down, high pitch position. In this manner, the clamping pressure of clamp 10 can be adjusted.

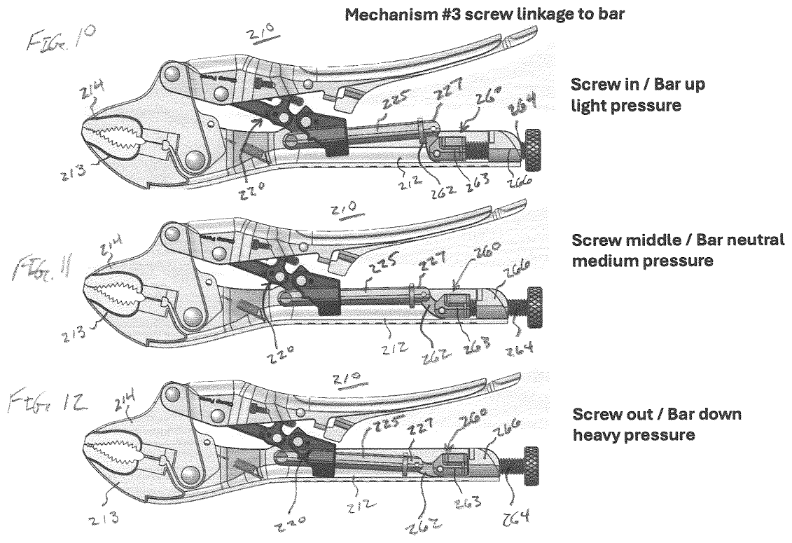

Turning now to FIGS. 6-9, another embodiment of a pitch bar self-adjusting clamp, generally designated 110 is illustrated. Clamp 110 is essentially the same as clamp 10, with a slightly different jaws 113 and 114, and a different adjustment mechanism 160. Each of the other elements is substantially identical to those described for clamp 10 and will be designated with a “1” in the hundreds position of the reference numeral. Adjustment mechanism 160 includes a plate 162, having a rack 163, carried by proximal end 127 of guide bar 125. A knob 164 with shaft 165 extends through an end cap 166 of handle 12 terminating in a pinion gear 168. Rotation of knob 164 rotates pinion gear 168. Pinion gear 168 engages rack 163 and when rotated drives plate 162 upwardly and downwardly as desired. As can be seen in FIG. 7, rotating knob 164 counter-clockwise moves guide bar 125 to the bar up, low pitch position while rotating knob 164 clockwise moved guide bar 125 to the bar down, high pitch position. In this manner, the clamping pressure of clamp 10 can be adjusted.

Referring now to FIGS. 10-12, another embodiment of a pitch bar self-adjusting clamp generally designated 210 is illustrated. Clamp 210 is essentially the same as clamp 10, with a different adjustment mechanism 260. Each of the other elements is substantially identical to those described for clamp 10 and will be designated with a “2” in the hundreds position of the reference numeral. Adjustment mechanism 260 includes a linkage 262 pivotally coupled between proximal end 227 of guide bar 225 and a cap 263 coupled to a screw 264 at tip 265. Screw 264 is threadably coupled to a threaded end plate 266 carried by the end of handle 212. With specific reference to FIG. 10, when screw 264 is threaded fully through end plate 266 linkage 262 is forced upwardly, positioning guide bar 225 into the bar up, low pitch position. As screw 264 is backed out of end plate 266, linkage 262 is moved toward a straightened position lowering proximal end 227 of guide bar 225 to a middle position (FIG. 11) and fully retracted to lower proximal end 227 of guide bar 225 to the bar down, high pitch position. In this manner, the clamping pressure of clamp 10 can be adjusted.

The present invention is described above with reference to illustrative embodiments. Those skilled in the art will recognize that changes and modifications may be made in the described embodiments without departing from the nature and scope of the present invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A pitch bar self-adjusting clamp comprising:
a fixture having a handle and an opposing stationary jaw;
a co-acting jaw pivoted to the fixture;
a lever pivoted to the co-acting jaw;
a guide bar having a proximal end and a distal end, the distal end pivotally coupled to the handle proximate the stationary jaw and the proximal end movably coupled to the handle proximate the terminal end;
a toggle assembly coupled between the lever and the guide bar, the toggle assembly including:
a locking element disposed on the guide for reciprocal and canting movement;
a link pivoted to the lever; and
a cam pivoted to the link and to the locking element and movable between a first condition permitting the locking element to reciprocate along the guide bar and a second condition bearing against the guide bar and canting the locking element into frictional engagement against the guide; and
an adjustment mechanism coupled to the proximal end of the guide bar for movement between a low pitch position and a high pitch position.

2. The pitch bar self-adjusting clamp as claimed in claim 1 wherein the adjustment mechanism further comprising a screw coupled to the terminal end of the handle and having a tip reciprocally movable in a forward and a rearward direction, the tip engaging a slanted end surface of the proximal end of the guide bar, pushing proximal end into a low pitch position with the tip in the forward direction and a high pitch position with the tip retracted in the rearward direction.

3. The pitch bar self-adjusting clamp as claimed in claim 2 wherein the adjustment mechanism further including a plate coupled to the terminal end of the handle adjacent the proximal end of guide bar and having a threaded aperture for receipt of the screw for reciprocating movement forwardly and rearwardly in engagement with the proximal end of the elongated bar.

4. The pitch bar self-adjusting clamp as claimed in claim 1 wherein the adjustment mechanism further comprising:
a plate having a rack carried by the proximal end of the guide bar;
a knob having shaft extending through terminal end of handle and terminating in a pinion gear engaging the rack; and
wherein rotation of the knob rotates the pinion gear which selectively drives the plate upwardly and downwardly to move the guide bar between the low pitch position and the high pitch position.

5. The pitch bar self-adjusting clamp as claimed in claim 1 wherein the adjustment mechanism further comprising:
an threaded end plate carried by the terminal end of the handle,
a screw having a tip, the screw threadably coupled to the threaded end plate and reciprocally movable inwardly and outwardly relative the threaded endplate;
a cap coupled to the tip of the screw;
a linkage pivotally coupled between the proximal end of the guide bar and the cap;
wherein movement of the screw inwardly and outwardly selectively drives the linkage upwardly and downwardly to move the guide bar between the low pitch position and the high pitch position.

6. A pitch bar self-adjusting clamp comprising:
a fixture having a handle and an opposing stationary jaw;
a co-acting jaw pivoted to the fixture;
a lever pivoted to the co-acting jaw;
a guide bar having a proximal end and a distal end, the distal end pivotally coupled to the handle proximate the stationary jaw and the proximal end movably coupled to the handle proximate the terminal end;
a toggle assembly coupled between the lever and the guide bar, the toggle assembly including:
a locking element disposed on the guide for reciprocal and canting movement;
a link pivoted to the lever;
a cam pivoted to the arm and to the locking element and movable between a first condition permitting the locking element to reciprocate along the guide bar and a second condition bearing against the guide bar and canting the locking element into frictional engagement against the guide, the cam including a camming surface characterized by an outward curvature that faces the guide bar and is angularly disposed relative thereto, the angular disposition of the cam surface determining a clamping force of the stationary jaw and the co-acting jaw; and
an adjustment mechanism coupled to the proximal end of the guide bar to adjust the angular disposition of the camming surface relative the guide bar.

7. The pitch bar self-adjusting clamp as claimed in claim 6 wherein the adjustment mechanism further comprising a screw coupled to the terminal end of the handle and having a tip reciprocally movable in a forward and a rearward direction, the tip engaging a slanted end surface of the proximal end of the guide bar to move the proximal end to adjust the angular disposition of the camming surface relative the guide bar.

8. The pitch bar self-adjusting clamp as claimed in claim 7 wherein the adjustment mechanism further including a plate coupled to the terminal end of the handle adjacent the proximal end of guide bar, and having a threaded aperture for receipt of the screw for reciprocating movement forwardly and rearwardly in engagement with the proximal end of the elongated bar.

9. The pitch bar self-adjusting clamp as claimed in claim 6 wherein the adjustment mechanism further comprising:
a plate having a rack carried by the proximal end of the guide bar;
a knob having shaft extending through terminal end of handle and terminating in a pinion gear engaging the rack; and
wherein rotation of the knob rotates the pinion gear which selectively drives the plate upwardly and downwardly to adjust the angular disposition of the camming surface relative the guide bar.

10. The pitch bar self-adjusting clamp as claimed in claim 1 wherein the adjustment mechanism further comprising:
an threaded end plate carried by the terminal end of the handle,
a screw having a tip, the screw threadably coupled to the threaded end plate and reciprocally movable inwardly and outwardly relative the threaded endplate;
a cap coupled to the tip of the screw;
a linkage pivotally coupled between the proximal end of the guide bar and the cap;
wherein movement of the screw inwardly and outwardly selectively drives the linkage upwardly and downwardly to adjust the angular disposition of the camming surface relative the guide bar.
